(19) United States
(12) Patent Application Publication
(10) Pub. No.: US 2025/0285475 A1
(43) Pub. Date: Sep. 11, 2025

(54) INFORMATION PROCESSING APPARATUS AND INFORMATION PROCESSING METHOD

(71) Applicant: TOYOTA JIDOSHA KABUSHIKI KAISHA, Toyota-shi Aichi-ken (JP)

(72) Inventors: Takamasa HIGUCHI, Chofu-shi Tokyo (JP); Jing MA, Koto-ku Tokyo (JP); Xiao SHAO, Kawasaki-shi Kanagawa-ken (JP); Lei ZHONG, Chuo-ku Tokyo (JP)

(73) Assignee: TOYOTA JIDOSHA KABUSHIKI KAISHA, Toyota-shi Aichi-ken (JP)

(21) Appl. No.: 19/045,645

(22) Filed: Feb. 5, 2025

(30) Foreign Application Priority Data
Mar. 11, 2024 (JP) 2024-037191

(51) Int. Cl. G07C 5/00; G06F 30/20; H04L 9/00

(52) U.S. Cl. CPC G07C 5/008; G06F 30/20; H04L 9/008

(57) ABSTRACT

An information processing apparatus includes a control unit configured to execute receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data, and performing statistical processing of each piece of data included in the first data for each measurement environment indicated by each piece of data included in the second data.

### CROSS-REFERENCE TO RELATED APPLICATION

This application claims priority to Japanese Patent Application No. 2024-037191 filed on Mar. 11, 2024, incorporated herein by reference in its entirety.

### BACKGROUND

### 1. Technical Field

The present disclosure relates to an information processing apparatus and an information processing method.

### 2. Description of Related Art

A technique of encrypting data and tallying the encrypted data without decrypting the encrypted data is known. Concerning this, for example, Japanese Unexamined Patent Application Publication No. 2020-119230 discloses a vehicle information collection system that acquires vehicle information, applies homomorphic encryption to the vehicle information, performs predetermined statistical processing on the encrypted vehicle information, exchanges the encrypted vehicle information with other vehicles and communicates with a center apparatus.

### SUMMARY

The present disclosure is directed to tallying encrypted measurement data for each measurement environment.

One aspect of an embodiment of the present disclosure is an information processing apparatus including a control unit configured to execute receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data, and performing statistical processing of each piece of data included in the first data for each measurement environment indicated by each piece of data included in the second data.

Another aspect of the embodiment of the present disclosure is an information processing apparatus mounted on a first vehicle, the information processing apparatus including a control unit configured to execute acquiring one or more pieces of measurement data generated by the first vehicle and one or more pieces of environment data each indicating a measurement environment of each piece of the measurement data, generating one or more pieces of first dummy data that simulates the measurement data acquired by the first vehicle, generating one or more pieces of second dummy data that corresponds to the first dummy data and simulates the environment data, generating first data by adding the first dummy data to one or more pieces of the measurement data, generating second data by adding the second dummy data to one or more pieces of the environment data, encrypting each piece of data included in the first data, and transmitting the first data and the second data to an information processing apparatus mounted on a second vehicle.

Yet another aspect of the embodiment of the present disclosure is an information processing method including receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data, and performing statistical processing of each piece of data included in the first data for each measurement environment indicated by each piece of data included in the second data.

A still further aspect includes a program for causing a computer to execute the method described above or a computer-readable storage medium that non-transitorily stores the program.

According to the present disclosure, it is possible to tally encrypted measurement data for each measurement environment.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating outline of processing to be executed by an information processing system according to an embodiment;

FIG. 2 is a view for explaining components of the information processing system according to the embodiment;

FIG. 3 is a flowchart of measurement data encryption processing to be executed by a control unit of a first in-vehicle apparatus included in the information processing system according to the embodiment;

FIG. 4 is a flowchart of dummy data generation processing to be executed by the control unit of the first in-vehicle apparatus included in the information processing system according to the embodiment; and

FIG. 5 is a flowchart of processing to be executed by a control unit of a second in-vehicle apparatus included in the information processing system according to the embodiment.

### DETAILED DESCRIPTION OF EMBODIMENTS

### Outline

It is conceivable to utilize various kinds of data measured by a vehicle. For example, by collecting data measured by a vehicle and performing statistical processing on the collected data, it is possible to acquire data that can be utilized in traveling of the vehicle. In this case, there is a case where not a center server apparatus that originally tallies measured data, but an arbitrary vehicle receives data measured by other vehicles, performs statistical processing on the data, and transmits the result to the center server apparatus. In some embodiments, in such a case, the measured data includes information regarding privacy of a user of the vehicle that has measured the data, and thus, the vehicle that has measured the data encrypts the data and transmits the encrypted data to a vehicle that tallies the data. Even when data is encrypted, the vehicle that tallies the data can perform statistical processing in a state where the received data is kept encrypted by utilizing a specific encryption method. Typically, if data is encrypted, statistical processing cannot be performed on the data unless the data is decrypted. However, by utilizing a specific encryption method such as homomorphic encryption, statistical processing can be performed on the data without the encrypted data being decrypted.

For example, it is desired to detect whether or not an event occurs using the measured data, the event indicating a state of a road such as closure of the road, road surface freezing, sagging of the road and congestion. In this case, there is a need to acquire a statistical value of data for each measurement point (or measurement area) at which the vehicle has measured the data. However, types of calculation which is to be performed using homomorphic encryption, or the like, and which can be performed on the encrypted data are limited. Specifically, while addition, multiplication, and the like, of simple numerical values indicating a travel distance, and the like, can be performed on the encrypted data, statistics on data cannot be taken for each measurement point or each measurement area. The present disclosure provides a technique for enabling a vehicle that tallies data to tally data that is kept encrypted for each measurement point or for each measurement area and perform statistical processing.

An information processing apparatus according to one aspect of the present disclosure is an information processing apparatus including a control unit configured to execute receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data, and performing statistical processing of each piece of data included in the first data for each measurement environment indicated by each piece of data included in the second data.

The measurement data is various kinds of data measured by the first vehicle using a sensor, or the like, provided in the first vehicle while the first vehicle is traveling.

The environment data is data indicating a measurement environment in which the first vehicle has acquired the measurement data. For example, the environment data may be position information indicating a position at which the first vehicle has acquired the measurement data. In this case, the environment data may include latitude and longitude information of a point at which the measurement data has been acquired.

The first dummy data is data that simulates the measurement data acquired by the first vehicle. The first dummy data includes a dummy value of data of the same type as a type of data to be detected by at least one of various kinds of sensors provided in the first vehicle.

The second dummy data is dummy data set as an environment in which the first dummy data has been measured. For example, when the environment data is position information indicating a position at which the first vehicle has acquired the measurement data, the second dummy data may include dummy latitude and longitude information corresponding to the first dummy data.

The information processing apparatus according to the present disclosure receives the first data and the second data and performs statistical processing on the encrypted first data for each measurement environment indicated by the second data that is not encrypted. In other words, the information processing apparatus according to the present disclosure can tally the encrypted measurement data for each measurement environment.

The control unit may be configured to execute the statistical processing without decrypting each piece of data included in the first data.

The information processing apparatus according to the present disclosure can protect privacy of a user of the vehicle by performing processing on data that is kept encrypted.

The control unit may be configured to perform the statistical processing on homomorphically encrypted data.

This enables the information processing apparatus according to the present disclosure to acquire measurement data that is acquired and encrypted by the first vehicle and perform statistical processing on the data that is kept encrypted.

The control unit may be configured to perform the statistical processing when the control unit determines that the first data and the second data of the number of pieces equal to or larger than a reference value have been received for one or more observation points indicated by the environment data.

This enables the information processing apparatus according to the present disclosure to secure a sufficient number of pieces of data and obtain a statistical result for the measurement data.

The control unit may be configured to calculate an average value of respective pieces of data included in the first data for each measurement environment indicated by each piece of data included in the second data in the statistical processing.

This enables the information processing apparatus according to the present disclosure to acquire tendency of data in the measurement environment on each road.

The control unit may be configured to transmit a result of the statistical processing to another information processing apparatus.

This enables the information processing apparatus according to the present disclosure to transmit the result of the statistical processing to another information processing apparatus, for example, a dedicated arithmetic apparatus or the like.

An information processing apparatus according to the present disclosure is an information processing apparatus mounted on a first vehicle, the information processing apparatus including a control unit configured to execute acquiring one or more pieces of measurement data generated by the first vehicle and one or more pieces of environment data each indicating a measurement environment of each piece of the measurement data, generating one or more pieces of first dummy data that simulates the measurement data acquired by the first vehicle, generating one or more pieces of second dummy data that corresponds to the first dummy data and simulates the environment data, generating first data by adding the first dummy data to one or more pieces of the measurement data, generating second data by adding the second dummy data to one or more pieces of the environment data, encrypting each piece of data included in the first data, and transmitting the first data and the second data to an information processing apparatus mounted on a second vehicle.

The information processing apparatus according to the present disclosure generates the first data by adding the first dummy data to the measurement data, generates the second data by adding the second dummy data to the environment data, encrypts the first data and transmits the first data and the second data.

For example, the information processing apparatus according to the present disclosure generates first data by adding to one piece of measurement data, a number of pieces of first dummy data for keeping the measurement data confidential and generates second data by adding to one piece of environment data, a number of pieces of second dummy data for keeping the environment data confidential.

This makes it impossible for the vehicle that receives the first data and the second data to estimate which is actual measurement data.

Thus, the information processing apparatus according to the present disclosure can transmit the measurement data and the environment data representing the measurement environment in which the measurement data has been acquired to other information processing apparatuses while keeping the data confidential with false data.

The control unit may be configured to encrypt each piece of data included in the first data by homomorphic encryption.

The information processing apparatus according to the present disclosure enables another information processing apparatus that has received the measurement data to perform statistical processing on the data that is kept encrypted.

The environment data may be position information of a point at which the measurement data has been acquired, and the control unit may be configured to generate position information of a point on a virtual route as the second dummy data, the virtual route being set as a traveling route of a virtual vehicle simulating the first vehicle.

The information processing apparatus according to the present disclosure can create false data that is not unnatural by generating a virtual route.

The control unit may be configured to generate position information indicating a predetermined number of positions as the second dummy data, the predetermined number of positions being selected randomly from points on peripheral roads of an observation point indicated by the environment data.

This enables the information processing apparatus according to the present disclosure to create more probable false data.

The control unit may be configured to generate a value of 0 as the first dummy data when addition calculation is utilized as the statistical processing of each piece of data included in the first data, the statistical processing being performed for each measurement environment indicated by each piece of data included in the second data, and the control unit may be configured to generate a value of 1 as the first dummy data when multiplication calculation is utilized as the statistical processing.

This enables the information processing apparatus according to the present disclosure to add to true data, a value that does not affect the statistical processing as dummy data.

The control unit may be configured to set a dummy measurement point at which the first dummy data is assumed to have been measured, determine whether or not a probability of being able to discriminate an actual measurement point is less than a predetermined threshold when the dummy measurement point and the actual measurement point indicated by the environment data are mixed, and transmit the first data and the second data to the information processing apparatus mounted on the second vehicle when the control unit determines that the probability of being able to discriminate the actual measurement point is less than the predetermined threshold.

This enables the information processing apparatus according to the present disclosure to transmit data that is reliably kept confidential by false data to other information processing apparatuses.

The information processing apparatus according to the present disclosure includes a control unit configured to execute receiving encrypted first data including one or more pieces of measurement data acquired by a first vehicle and one or more pieces of first dummy data that simulates the measurement data, second data including one or more pieces of environment data each indicating a measurement environment of each piece of the measurement data and one or more pieces of second dummy data that corresponds to the first dummy data and simulates the environment data, and a result of statistical processing performed on each piece of data included in the first data that is kept encrypted for each measurement environment indicated by each piece of data included in the second data, and decrypting the received first data and the received result.

This enables the information processing apparatus according to the present disclosure to decrypt the statistical result safely transmitted by being encrypted and utilize the decrypted statistical result.

An information processing method according to one aspect of the present disclosure includes receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data, and performing statistical processing of each piece of data included in the first data for each measurement environment indicated by each piece of data included in the second data.

Performing the statistical processing may include executing the statistical processing without decrypting each piece of data included in the first data.

Performing the statistical processing may include performing the statistical processing on homomorphically encrypted data.

Performing the statistical processing may include performing the statistical processing when the first data and the second data of the number of pieces equal to or larger than a reference value are received for one or more observation points indicated by the environment data.

Performing the statistical processing may include calculating an average value of respective pieces of data included in the first data for each measurement environment indicated by each piece of data included in the second data.

The information processing method may further include transmitting a result of the statistical processing to another information processing apparatus.

An information processing method according to one aspect of the present disclosure is an information processing method to be performed by an information processing apparatus mounted on a first vehicle, the information processing method including acquiring one or more pieces of measurement data generated by the first vehicle and one or more pieces of environment data each indicating a measurement environment of each piece of the measurement data, generating one or more pieces of first dummy data that simulates the measurement data acquired by the first vehicle, generating one or more pieces of second dummy data that corresponds to the first dummy data and simulates the environment data, generating first data by adding the first dummy data to one or more pieces of the measurement data, generating second data by adding the second dummy data to one or more pieces of the environment data, encrypting each piece of data included in the first data, and transmitting the first data and the second data to an information processing apparatus mounted on a second vehicle.

A specific embodiment of the present disclosure will be described below based on the drawings. A hardware configuration, a module configuration, a functional configuration, and the like, described in each embodiment do not intend to limit a technical scope of the disclosure thereto unless otherwise described.

### Embodiment

### Outline of Processing of Information Processing System

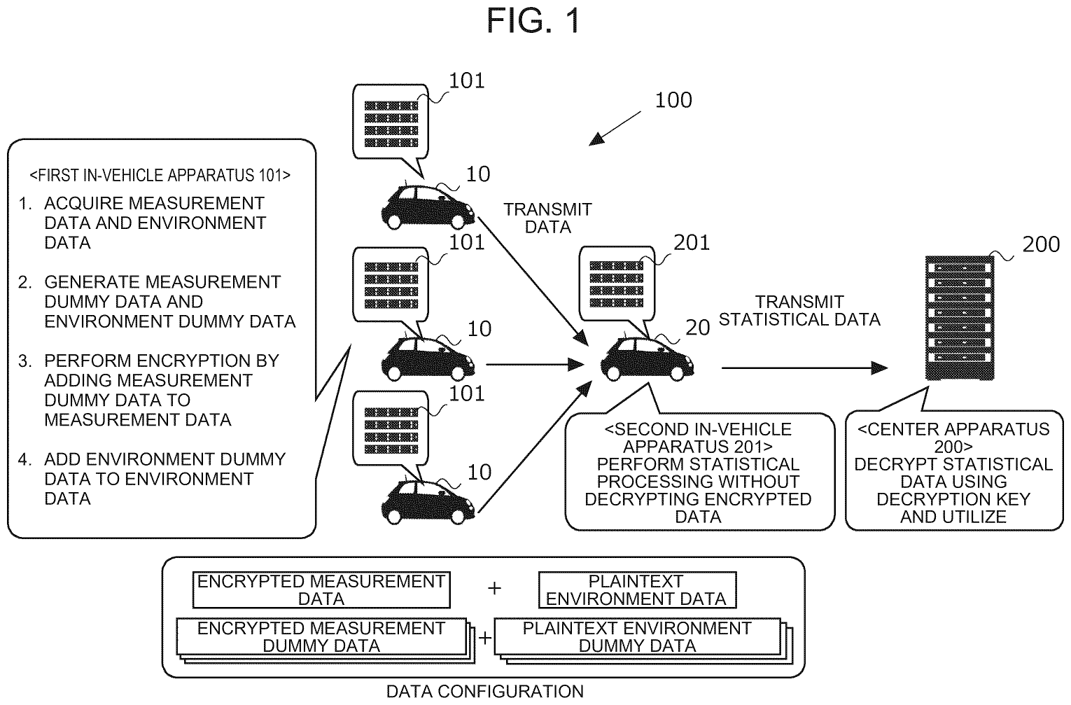

Outline of processing to be performed by an information processing system according to an embodiment will be described with reference to FIG. 1. FIG. 1 illustrates outline of processing to be executed by an information processing system 100 according to the embodiment. Here, the information processing system 100 according to the embodiment includes, for example, first in-vehicle apparatuses 101 respectively mounted on a plurality vehicles 10 that are vehicles that sense data, and a second in-vehicle apparatus 201 mounted on a vehicle 20 that is a vehicle having a function of aggregating the data. The first in-vehicle apparatus 101 and the second in-vehicle apparatus 201 may be information terminals for implementing a car navigation system or may be dedicated information terminals incorporated into the vehicle 10 and the vehicle 20. The first in-vehicle apparatus 101 encrypts measurement data detected by a sensor, or the like, provided in the vehicle 10 and transmits the measurement data to the second in-vehicle apparatus 201 along with plaintext environment data. Then, the second in-vehicle apparatus 201 performs statistical processing on the data received from the plurality of vehicles 10 while the data is kept encrypted and transmits the received data and a result of the statistical processing, and the like, to an external server apparatus, or the like. The first in-vehicle apparatus 101 and the second in-vehicle apparatus 201 are one example of the information processing apparatus of the present disclosure. The first in-vehicle apparatus 101 is sometimes referred to as a first information processing apparatus, and the second in-vehicle apparatus 201 is sometimes referred to as a second information processing apparatus.

First, the first in-vehicle apparatus 101 of the information processing system 100 acquires measurement data and environment data via a sensor, or the like, provided in the vehicle 10. Here, the measurement data is data acquired by the sensor. For example, the measurement data may be an image captured by an in-vehicle camera or may be speed or acceleration of the vehicle 10 detected by an acceleration sensor or data indicating whether or not an obstacle exists on a road, detected by a LiDAR, or the like, mounted on the vehicle 10. The environment data is data indicating a measurement environment of each piece of the measurement data. Specifically, the environment data may be position information of a location where each piece of the measurement data has been measured.

Next, the first in-vehicle apparatus 101 generates dummy data respectively corresponding to the measurement data and the environment data. For example, the dummy data of the measurement data may be dummy measurement data. Specifically, the dummy data of the measurement data may be data having a value of 0 or 1. The dummy data of the measurement data is referred to as measurement dummy data. The measurement dummy data is one example of “first dummy data”. Further, the dummy data of the environment data is data corresponding to the dummy data of the measurement data and indicating a dummy measurement environment set as an environment in which the dummy data has been measured. For example, the dummy data of the environment data may be dummy position information. The dummy data of the environment data is referred to as environment dummy data. The environment dummy data is one example of “second dummy data”.

Subsequently, the first in-vehicle apparatus 101 adds a plurality of pieces of measurement dummy data to the measurement data and encrypts the data. For example, the first in-vehicle apparatus 101 encrypts the measurement data and the measurement dummy data using homomorphic encryption. The homomorphic encryption refers to encryption that enables calculation with encrypted text.

Then, the first in-vehicle apparatus 101 adds a plurality of pieces of environment dummy data to the environment data. The first in-vehicle apparatus 101 does not encrypt the environment data and the environment dummy data. In other words, the first in-vehicle apparatus 101 generates data by adding a plurality of pairs of encrypted measurement dummy data and plaintext environment dummy data corresponding to the encrypted measurement dummy data to a pair of encrypted measurement data and plaintext environment data corresponding to the encrypted measurement data.

Subsequently, the first in-vehicle apparatus 101 transmits a pair of the encrypted measurement data and the measurement dummy data and a pair of the environment data and the environment dummy data that are not encrypted to the second in-vehicle apparatus 201 of the vehicle 20. Then, the second in-vehicle apparatus 201 performs statistical processing of the data that is kept encrypted without decrypting the encrypted data. For example, the second in-vehicle apparatus 201 may calculate a statistical value of the measurement data for each measurement environment indicated by the environment data corresponding to the measurement data on a one-to-one basis. Here, the statistical value may be an average value of the measurement data calculated for each measurement environment.

Then, the second in-vehicle apparatus 201 transmits statistical data to a center apparatus 200. The center apparatus 200 decrypts the received statistical data using a decryption key and utilizes the decrypted statistical data in various kinds of calculation.

In this manner, in the present embodiment, the information processing system 100 generates data by adding a pair of encrypted measurement dummy data and plaintext environment dummy data to a pair of encrypted measurement data and plaintext environment data and performs statistical processing on the data without decrypting the data.

### Configuration of Information Processing System

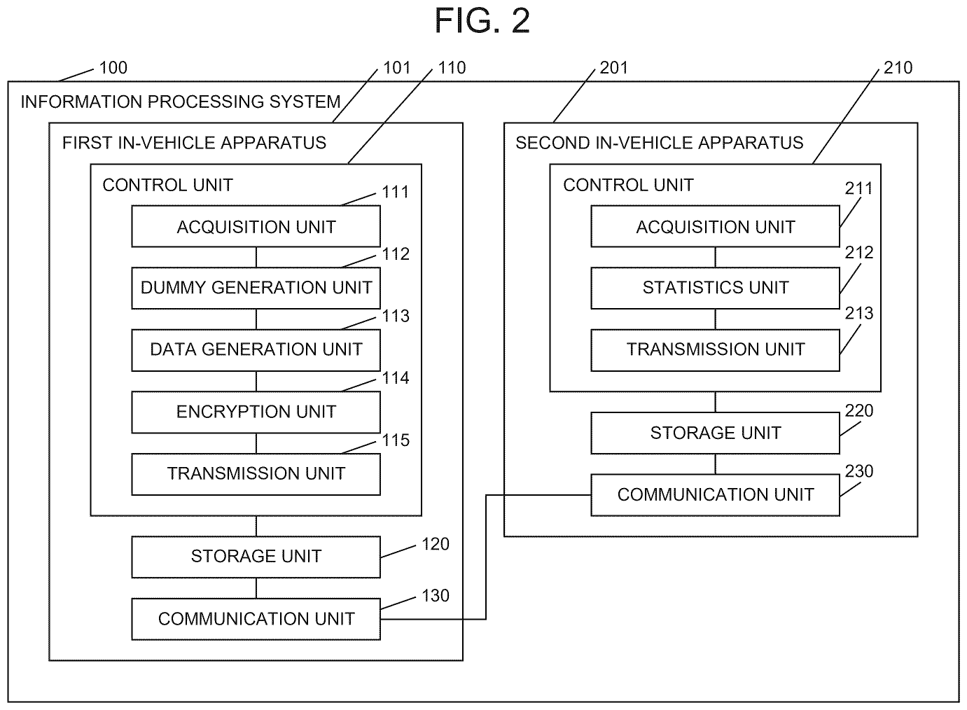

FIG. 2 explains components of the information processing system 100 according to the embodiment.

The information processing system 100 according to the present embodiment includes the first in-vehicle apparatus 101 and the second in-vehicle apparatus 201. The first in-vehicle apparatus 101 includes a control unit 110, a storage unit 120, and a communication unit 130. Further, the second in-vehicle apparatus 201 includes a control unit 210, a storage unit 220, and a communication unit 230. In the information processing system 100, the first in-vehicle apparatuses 101 mounted on a plurality of vehicles 10 transmit encrypted data to the second in-vehicle apparatuses 201 mounted on the vehicles 20 that are fewer than the vehicles 10, and the second in-vehicle apparatuses 201 aggregate the received data. Note that there may be a plurality of vehicles 20. The first in-vehicle apparatus 101 and the second in-vehicle apparatus 201 may be, for example, in-vehicle terminals that implement a car navigation system, or the like, or may be dedicated in-vehicle terminals for executing processing described in the present embodiment.

The vehicle 20 is a vehicle that takes statistics of the data generated by the vehicle 10. The vehicle 20 may be selected by a management apparatus that manages the information processing system 100. For example, when statistics are taken for each of a plurality of areas, the management apparatus may select the vehicle 20 from a plurality of vehicles traveling in a predetermined area.

First, components of the first in-vehicle apparatus 101 will be described.

The control unit 110 is implemented with a processor such as a central processing unit (CPU) or a graphics processing unit (GPU) and a memory. The control unit 110 includes an acquisition unit 111, a dummy generation unit 112, a data generation unit 113, an encryption unit 114, and a transmission unit 115 as functional modules. These functional modules may be implemented by programs being executed by the control unit 110. Note that the control unit 110 is sometimes referred to as a first control unit.

The acquisition unit 111 acquires measurement data acquired by a sensor, or the like, provided in the vehicle 10, and environment data indicating a measurement environment of the measurement data. The acquisition unit 111 may perform communication with an electronic control unit (ECU) that controls the sensor, or the like, provided in the vehicle 10 via the communication unit 130 to acquire the measurement data and the environment data.

The dummy generation unit 112 generates measurement dummy data that is dummy data simulating the measurement data and environment dummy data that is dummy data corresponding to the measurement dummy data and simulating the environment data. The dummy generation unit 112 can set a value that does not affect statistical calculation of the measurement data as the measurement dummy data. Specifically, the dummy generation unit 112 can set a value of 0 as the measurement dummy data when addition calculation is utilized as the statistical processing of the measurement data and can set a value of 1 as the measurement dummy data when multiplication calculation is utilized as the statistical processing of the measurement data.

The data generation unit 113 generates first data by adding one or more pieces of the measurement dummy data to one or more pieces of the measurement data. Further, the data generation unit 113 generates second data by adding one or more pieces of the environment dummy data corresponding to the measurement dummy data to one or more pieces of the environment data corresponding to the measurement data. In other words, the data generation unit 113 generates data by adding a pair of one or more pieces of measurement dummy data and environment dummy data to a pair of one or more pieces of the measurement data and the environment data.

The encryption unit 114 encrypts each piece of data included in the first data. In other words, the encryption unit 114 encrypts the measurement data and the measurement dummy data. The encryption unit 114 may encrypt each piece of data included in the first data using homomorphic encryption.

The transmission unit 115 transmits a pair of one or more pieces of the encrypted first data and plaintext second data to the second in-vehicle apparatus 201. The transmission unit 115 performs wireless communication with the communication unit 230 of the second in-vehicle apparatus 201 via the communication unit 130. The transmission unit 115 may transmit the data to the second in-vehicle apparatus 201 through communication via a wide area network or may transmit the data to the second in-vehicle apparatus 201 through vehicle-to-vehicle communication.

The storage unit 120 is a main storage device such as a random access memory (RAM) or a read only memory (ROM), or an auxiliary storage device such as an erasable programmable ROM (EPROM), a hard disk drive and a removable medium. In the auxiliary storage device, an operating system (OS), various kinds of programs, various kinds of tables, and the like, are stored, and respective functions that match predetermined purposes of the respective units of the control unit 110 can be implemented by the programs stored therein being executed. However, some or all of the functions may be implemented by a hardware circuit such as an application specific integrated circuit (ASIC) or a field programmable gate array (FPGA).

The storage unit 120 stores data, and the like, to be used or generated in processing to be performed by the control unit 110. The storage unit 120 may store programs, and the like, to be used for encrypting data.

The communication unit 130 is constituted with a communication circuit that performs wireless communication. The communication unit 130 may be, for example, a communication circuit that performs wireless communication using 4th generation (4G) or may be a communication circuit that performs wireless communication using 5th generation (5G). The communication unit 130 may be a communication circuit that performs wireless communication using long term evolution (LTE) or may be a communication circuit that performs communication using low power wide area (LPWA). The communication unit 130 may be a communication circuit that performs wireless communication using Wi-Fi (registered trademark).

Components of the second in-vehicle apparatus 201 will be described next.

The control unit 210 is implemented with a processor such as a CPU or a GPU and a memory. The control unit 210 includes an acquisition unit 211, a statistics unit 212 and a transmission unit 213 as functional modules. These functional modules may be implemented by programs being executed by the control unit 210. Note that the control unit 210 is sometimes referred to as a second control unit.

The acquisition unit 211 acquires one or more pieces of encrypted first data and plaintext second data from the first in-vehicle apparatus 101. The acquisition unit 211 may receive one or more pieces of encrypted first data and plaintext second data from the first in-vehicle apparatus 101 via the communication unit 230.

The statistics unit 212 performs statistical processing of each piece of data included in the first data for each measurement environment indicated by each piece of data included in the second data. The statistics unit 212 performs statistical processing on the first data that is kept encrypted based on each piece of data included in the plaintext second data. For example, the statistics unit 212 may calculate an average value of the measurement data for each measurement point (or measurement area) of each piece of the measurement data indicated by the second data without decrypting the measurement data.

The transmission unit 213 transmits statistical data calculated by the statistics unit 212 to an external server apparatus, or the like. Here, the external server apparatus, or the like, is a center apparatus, or the like, that performs calculation to utilize the measurement data measured by the vehicle 10 in various kinds of applications. The transmission unit 213 transmits the statistical data to the external server apparatus, or the like, via a wide area network such as the Internet via the communication unit 230.

The storage unit 220 is a main storage device such as a RAM or a ROM or an auxiliary storage device such as an EPROM, a hard disk drive and a removable medium.

In the auxiliary storage device, an operating system (OS), various kinds of programs, various kinds of tables, and the like, are stored, and respective functions that match predetermined purposes of the respective units of the control unit 210 can be implemented by the programs stored therein being executed. However, some or all of the functions may be implemented by a hardware circuit such as an ASIC and an FPGA.

The storage unit 220 stores data, and the like, to be used or generated in processing to be performed by the control unit 210. The storage unit 220 may store programs, and the like, to be used in statistical processing of the first data.

The communication unit 230 is constituted with a communication circuit that performs wireless communication. The communication unit 230 may be, for example, a communication circuit that performs wireless communication using 4G or may be a communication circuit that performs wireless communication using 5G. Alternatively, the communication unit 230 may be a communication circuit that performs wireless communication using LTE or may be a communication circuit that performs communication using LPWA. Alternatively, the communication unit 230 may be a communication circuit that performs wireless communication using Wi-Fi (registered trademark).

### Operation of First In-Vehicle Apparatus

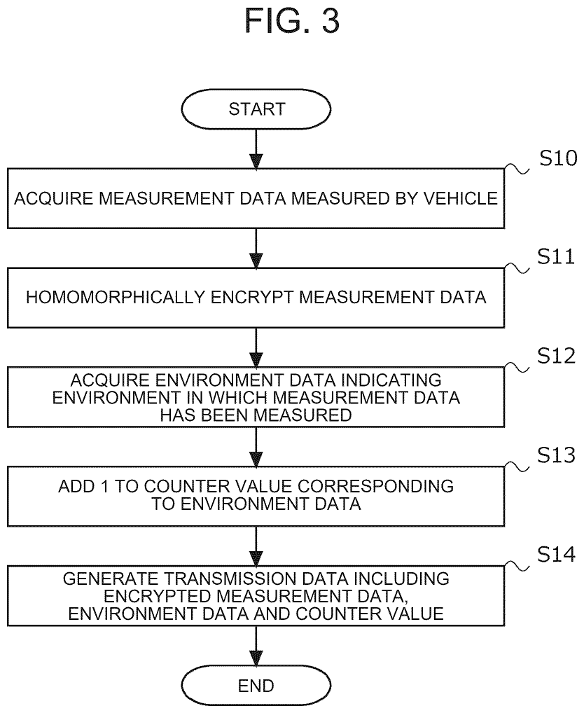

Specific content of processing to be performed by the first in-vehicle apparatus 101 included in the information processing system 100 will be described next. First, processing of the first in-vehicle apparatus 101 encrypting data measured by the vehicle 10 will be described. FIG. 3 is a flowchart of measurement data encryption processing to be executed by the control unit 110 of the first in-vehicle apparatus 101 included in the information processing system 100 according to the embodiment.

The first in-vehicle apparatus 101 included in the information processing system 100 starts processing described in FIG. 3 when the vehicle 10 on which the first in-vehicle apparatus 101 is mounted starts traveling, and periodically repeats the processing at regular intervals. Note that the first in-vehicle apparatus 101 may start processing in step S10 when the first in-vehicle apparatus 101 accepts some kind of input from a user of the vehicle 10.

In step S10, the acquisition unit 111 acquires measurement data via a sensor provided in the vehicle 10. Here, the measurement data may be specifically an image captured by an in-vehicle camera. Alternatively, the measurement data may be speed or acceleration of the vehicle 10 detected by an acceleration sensor or data indicating whether or not an obstacle exists on a road, detected by a LiDAR, or the like, mounted on the vehicle 10.

In step S11, the encryption unit 114 homomorphically encrypts the measurement data acquired by the acquisition unit 111 in step S10. Here, as the homomorphic encryption, the Okamoto-Uchiyama cryptosystem, the Paillier cryptosystem, the ElGamal cryptosystem, RSA encryption, the Boneh-Goh-Nissim cryptosystem, lattice cryptography, fully homomorphic encryption based on lattice cryptography by Gentry, or the like, may be used.

In step S12, the acquisition unit 111 acquires environment data indicating an environment in which the measurement data acquired in step S10 has been measured. One piece of environment data corresponds to one piece of measurement data. The environment data may be, for example, position information indicating a position at which each piece of the measurement data has been measured. Specifically, the environment data may be latitude and longitude information (which may include altitude information) of the position at which the measurement data has been measured. The environment data is not limited to the position information indicating the position at which the measurement data has been measured and may be any data as long as the data indicates the environment in which the measurement data has been measured.

For example, the environment data may be information indicating hours in which the measurement data has been measured, an ID of a road link of a road on which the measurement data has been acquired, or a lane of the road on which the measurement data has been acquired. Further, for example, the environment data may be information indicating a traveling direction of the vehicle that has acquired the measurement data when the measurement data has been acquired, vehicle speed of the vehicle that has acquired the measurement data when the measurement data has been acquired, a vehicle model or a vehicle type of the vehicle that has acquired the measurement data, or the like.

In step S13, the data generation unit 113 assigns 1 to a counter value corresponding to the environment data. The counter value is data to be transmitted to the second in-vehicle apparatus 201 by the first in-vehicle apparatus 101 along with the measurement data and the corresponding environment data. When a sensor mounted on the vehicle 10 performs sensing once in a certain measurement environment, 1 is added to the counter value. In other words, the counter value indicates the number of pieces of the acquired measurement data in the measurement environment indicated by the environment data. The second in-vehicle apparatus 201 can recognize how many pieces of measurement data corresponding to a specific measurement environment are collected by summing the counter values included in the collected transmission data.

In step S14, the data generation unit 113 generates transmission data including the measurement data encrypted in step S11, the environment data corresponding to the measurement data, and the counter value to which 1 is assigned in step S13. The data generation unit 113 may make a pair of the encrypted measurement data and plaintext environment data corresponding to the measurement data to make the transmission data or may make the transmission data including a plaintext counter value separately from the pair of the measurement data and the environment data.

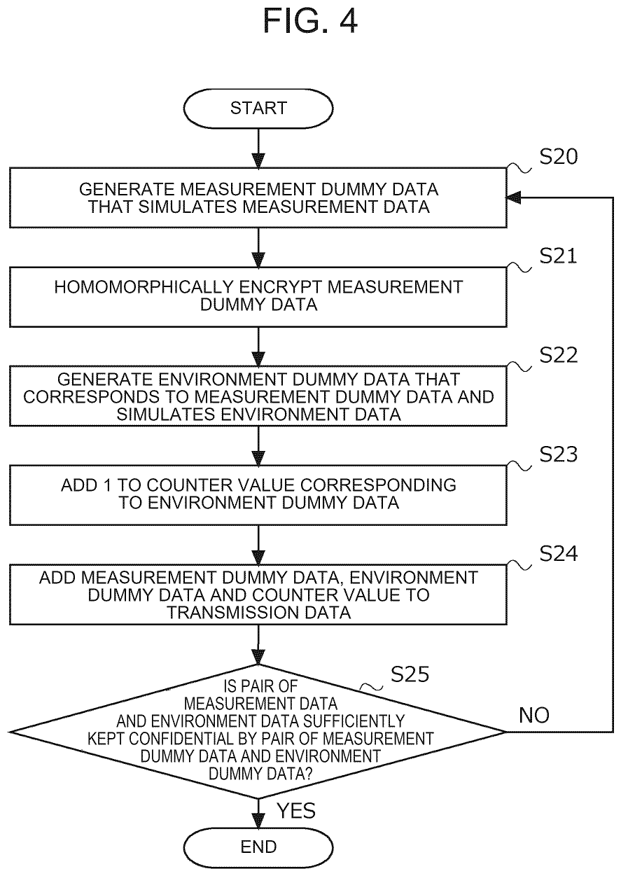

Processing of the first in-vehicle apparatus 101 generating dummy data for keeping the data measured by the vehicle 10 confidential will be described next. FIG. 4 is a flowchart of dummy data generation processing to be executed by the control unit 110 of the first in-vehicle apparatus 101 included in the information processing system 100 according to the embodiment.

The first in-vehicle apparatus 101 included in the information processing system 100 starts processing described in FIG. 4 when the vehicle 10 on which the first in-vehicle apparatus 101 is mounted starts traveling, and periodically repeats the processing at regular intervals. Note that the first in-vehicle apparatus 101 may start processing in step S20 when the first in-vehicle apparatus 101 accepts some kind of input from the user of the vehicle 10. The processing described in FIG. 4 may be performed in parallel to the processing described in FIG. 3 or may be performed after the processing described in FIG. 3. When the processing described in FIG. 3 and the processing described in FIG. 4 are repeated, the processing described in FIG. 3 and the processing described in FIG. 4 may be alternately performed.

In step S20, the dummy generation unit 112 generates measurement dummy data that is dummy data simulating the measurement data. The measurement dummy data has a value that does not affect a calculation result in calculation of performing statistical processing on the measurement data. For example, when the statistical processing on the measurement data includes addition calculation, the measurement dummy data may have a value of zero. Further, when the statistical processing on the measurement data includes multiplication calculation, the measurement dummy data may have a value of one.

In step S21, the encryption unit 114 homomorphically encrypts the measurement dummy data. The encryption unit 114 encrypts the measurement dummy data using the same method as the method in step S11.

In step S22, the dummy generation unit 112 generates environment dummy data that corresponds to the measurement dummy data and simulates the environment data. Specifically, the dummy generation unit 112 generates the environment dummy data indicating a value indicating an environment set as an environment in which the measurement dummy data has been measured. For example, the dummy generation unit 112 generates the environment dummy data indicating position information (for example, latitude and longitude information (which may include altitude information)) indicating a position set as a position at which the measurement dummy data has been measured. Specifically, as the environment dummy data, position information indicating a predetermined number of positions randomly selected from points on peripheral roads of an actual observation point indicated by true environment data may be employed. Alternatively, the dummy generation unit 112 sets a predetermined number of dummy vehicles and generates dummy trajectories on which the dummy vehicles have traveled. Then, a predetermined number of points may be extracted on the dummy trajectories, and position information indicating the positions may be employed as the environment dummy data.

In step S23, the data generation unit 113 assigns 1 to a counter value corresponding to the environment dummy data. In other words, the counter value indicates that (it is set as) one piece of measurement dummy data has been acquired in the measurement environment indicated by the environment dummy data.

In step S24, the data generation unit 113 adds the measurement dummy data encrypted in step S21, the environment dummy data corresponding to the measurement dummy data and the counter value to which 1 is assigned in step S23 to the transmission data. The data generation unit 113 may make a pair of the encrypted measurement dummy data and the plaintext environment dummy data corresponding to the measurement dummy data and add the pair to the transmission data. Here, the transmission data is transmission data generated in the processing (step S14) in FIG. 3.

In step S25, the data generation unit 113 determines whether or not the pair of the measurement data and the environment data is sufficiently kept confidential by the pair of the measurement dummy data and the environment dummy data in the transmission data generated in step S24.

For example, the data generation unit 113 may determine whether or not the number of pairs of the measurement dummy data and the environment dummy data is larger than the number of pairs of the measurement data and the environment data by a given number in the transmission data. Alternatively, the data generation unit 113 may determine whether or not a ratio of the number of pairs of the measurement dummy data and the environment dummy data with respect to the number of pairs of the measurement data and the environment data is equal to or larger than a given ratio in the transmission data. Alternatively, the data generation unit 113 may determine whether or not a probability of being able to discriminate the actual measurement point is less than a predetermined threshold when the dummy measurement point employed as the environment dummy data and the actual measurement point indicated by the environment data are mixed.

When the data generation unit 113 determines that the pair of the measurement data and the environment data is sufficiently kept confidential by the pair of the measurement dummy data and the environment dummy data in the transmission data, a positive determination result is obtained in the present step.

When the positive determination result is obtained in the present step, the processing ends.

When a negative determination result is obtained in the present step, the processing transitions to step S20.

If both the processing in FIG. 3 and the processing in FIG. 4 end, the transmission unit 115 transmits the transmission data, that is, data including one or more pairs of the measurement data and the environment data and one or more pairs of the measurement dummy data and the environment dummy data to the second in-vehicle apparatus 201. Further, when the processing described in FIG. 3 and the processing described in FIG. 4 are repeatedly performed, the processing may be performed as follows. In this case, at a time point at which both the processing in step S14 and processing in step S25 that is performed the same number of times as the processing in step S14 are completed, the data including one or more pairs of the measurement data and the environment data and one or more pairs of the measurement dummy data and the environment dummy data may be transmitted to the second in-vehicle apparatus 201. The above processing may be repeatedly performed at the above-described timing.

### Operation of Second In-Vehicle Apparatus

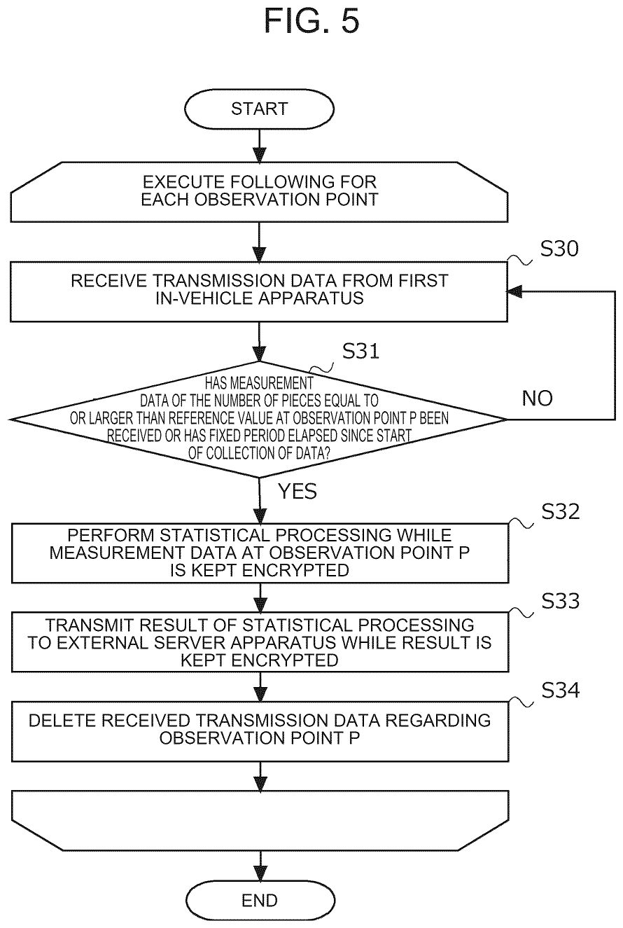

Specific content of processing to be performed by the second in-vehicle apparatus 201 included in the information processing system 100 will be described next. Specifically, operation of the second in-vehicle apparatus 201 performing statistical processing on the data received by the vehicle 20 will be described. FIG. 5 is a flowchart of processing to be executed by the control unit 210 of the second in-vehicle apparatus 201 included in the information processing system 100 according to the embodiment. The control unit 210 repeats processing from step S30 to step S34 for each observation point. Here, the observation point may be a local point or a given range (observation area). “Each observation point” may be a point or an area determined in advance. For example, when a target region includes a plurality of regions divided by mesh, the processing from step S30 to S34 may be repeated for each of the plurality of regions.

In step S30, the acquisition unit 211 receives the transmission data from the first in-vehicle apparatus 101 mounted on the vehicle 10. The acquisition unit 211 receives the transmission data generated by the first in-vehicle apparatus 101 in step S14 and step S25. In other words, the acquisition unit 211 receives data including one or more pairs of the measurement data and the environment data and one or more pairs of the measurement dummy data and the environment dummy data, the data being transmitted to the second in-vehicle apparatus 201 by the first in-vehicle apparatus 101.

In step S31, the statistics unit 212 determines whether data of the number of pieces equal to or larger than a reference value has been received or a fixed period has elapsed since start of collection of the measurement data for the measurement data acquired at the target observation point. The environment data is plaintext, so that the statistics unit 212 can determine the observation point corresponding to each of a plurality of pieces of the measurement data. For example, when the target region includes a plurality of regions divided by mesh, whether a predetermined number of pieces of measurement data have been acquired may be determined for each of the plurality of regions.

When the statistics unit 212 determines that data of the number of pieces equal to or larger than the reference value has been received or a fixed period has elapsed since start of collection of the measurement data for the measurement data acquired at the target observation point, a positive determination result is obtained in the present step.

When the positive determination result is obtained in the present step, the processing transitions to step S32.

When a negative determination result is obtained in the present step, the processing transitions to step S30.

When the processing transitions to step S32, the statistics unit 212 performs statistical processing on a given number of pieces of measurement data acquired at the observation point P while the measurement data is kept encrypted. For example, the statistics unit 212 may perform processing of calculating an average value for the measurement data that is acquired at the observation point P and is kept encrypted.

Then, in step S33, the transmission unit 213 transmits a result of the statistical processing calculated in step S32, which is data that is kept encrypted, to an external server apparatus. The transmission unit 213 transmits the encrypted result of the statistical processing to an external server apparatus such as a center apparatus having a function of receiving data from the vehicle 10 and the vehicle 20 and utilizing the received data in various kinds of calculation. The result of the statistical processing may be transmitted along with data indicating the corresponding observation point (point or area). Further, the transmission unit 213 may transmit the data itself received from the first in-vehicle apparatus 101 to the external server apparatus at the same time as well as the result of the statistical processing. The received data relating to the target observation point is stored in the storage unit 220 by the control unit 210. In step S34, the transmitted data relating to the target observation point may be deleted by the control unit 210.

The center apparatus, or the like, that has received the result of the statistical processing from the second in-vehicle apparatus 201 decrypts the encrypted result of the statistical processing using a decryption key. Then, the center apparatus, or the like, can utilize the decrypted statistical value in various kinds of calculation.

In the present embodiment, the information processing system 100 can keep the true measurement data and environment data confidential by the dummy data that simulates the measurement data and the environment data measured by the vehicle 10 and perform statistical processing of the measurement data while keeping the data encrypted. In other words, the information processing system 100 can transmit measurement data regarding privacy of the user of the vehicle 10 to the vehicle 20 in a state where the measurement data is kept confidential, and the vehicle 20 can perform statistical processing on the measurement data that is kept confidential.

### Modification 1

In the above embodiment, all the first in-vehicle apparatuses 101 transmit measurement data measured in various measurement environments to the second in-vehicle apparatus 201. However, only the first in-vehicle apparatus 101 of the vehicle 10 that satisfies a specific measurement position or a measurement condition designated from the center apparatus, or the like, may transmit only the measurement data that satisfies the condition to the second in-vehicle apparatus 201. In other words, when the center apparatus designates the measurement position, the measurement condition, and the like, only the first in-vehicle apparatus 101 mounted on the vehicle 10 that can satisfy the condition encrypts the measurement data and transmits the encrypted measurement data to the second in-vehicle apparatus 201. In this event, the first in-vehicle apparatus 101 may transmit only the measurement data to the second in-vehicle apparatus 201 without adding the environment data to the transmission data. This is because the measurement position, the measurement condition, and the like, are limited in advance, and thus, statistical processing can be performed as is without classifying the measurement data for each measurement position or measurement environment.

However, if only the first in-vehicle apparatus 101 of a specific vehicle 10 that satisfies the measurement condition transmits the transmission data to the second in-vehicle apparatus 201, there is a possibility that history of the position information of the vehicle 10, history of other states, or the like, may be acquired by the vehicle 20. Thus, also the first in-vehicle apparatus 101 mounted on the vehicle 10 that does not satisfy the designated measurement condition also transmits the encrypted measurement dummy data to the second in-vehicle apparatus 201 at a constant rate. Then, the second in-vehicle apparatus 201 performs statistical processing while the measurement data received from the specific vehicle 10 that satisfies the measurement condition and the measurement dummy data received from the vehicle 10 that does not satisfy the measurement condition are kept encrypted. As such, it is possible to acquire a statistical value of the measurement data acquired in a predetermined measurement environment while preventing leakage of information regarding privacy of the specific vehicle 10 that satisfies the measurement condition.

### Other Modifications

The above embodiment is merely one example, and the present disclosure can be implemented while change is made as appropriate within a range not deviating from the gist.

The present disclosure can be implemented by a computer program implementing the functions described in the above embodiment being supplied to a computer and one or more processors of the computer reading and executing the program. Such a computer program may be provided to the computer using a non-transitory computer-readable storage medium that can be connected to a system bus of the computer or may be provided to the computer via a network. The non-transitory computer-readable storage medium includes, for example, an arbitrary type of disk such as a magnetic disk (such as a floppy (registered trademark) disk and a hard disk drive (HDD)) and an optical disk (such as a CD-ROM, a DVD disk and a blue-ray disk), a read only memory (ROM), a random access memory (RAM), an EPROM, an EEPROM, a magnetic card, a flash memory, an optical card, and an arbitrary type of medium appropriate for storing an electronic command.

What is claimed is:

1. An information processing apparatus comprising a control unit configured to execute:
receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data; and
performing statistical processing of each piece of data included in the first data for each measurement environment indicated by each piece of data included in the second data.

2. The information processing apparatus according to claim 1, wherein the control unit is configured to execute the statistical processing without decrypting each piece of data included in the first data.

3. The information processing apparatus according to claim 2, wherein the control unit is configured to perform the statistical processing on homomorphically encrypted data.

4. The information processing apparatus according to claim 1, wherein the control unit is configured to perform the statistical processing when the control unit determines that the first data and the second data of the number of pieces equal to or larger than a reference value have been received for one or more observation points indicated by the environment data.

5. The information processing apparatus according to claim 1, wherein the control unit is configured to calculate an average value of respective pieces of data included in the first data for each measurement environment indicated by each piece of data included in the second data in the statistical processing.

6. The information processing apparatus according to claim 1, wherein the control unit is configured to transmit a result of the statistical processing to another information processing apparatus.

7. An information processing apparatus mounted on a first vehicle, the information processing apparatus comprising a control unit configured to execute:
acquiring one or more pieces of measurement data generated by the first vehicle and one or more pieces of environment data each indicating a measurement environment of each piece of the measurement data;
generating one or more pieces of first dummy data that simulates the measurement data acquired by the first vehicle;
generating one or more pieces of second dummy data that corresponds to the first dummy data and simulates the environment data;
generating first data by adding the first dummy data to one or more pieces of the measurement data;
generating second data by adding the second dummy data to one or more pieces of the environment data;
encrypting each piece of data included in the first data; and
transmitting the first data and the second data to an information processing apparatus mounted on a second vehicle.

8. The information processing apparatus according to claim 7, wherein the control unit is configured to encrypt each piece of data included in the first data by homomorphic encryption.

9. The information processing apparatus according to claim 7, wherein:
the environment data is position information of a point at which the measurement data has been acquired; and
the control unit is configured to generate position information of a point on a virtual route as the second dummy data, the virtual route being set as a traveling route of a virtual vehicle simulating the first vehicle.

10. The information processing apparatus according to claim 7, wherein the control unit is configured to generate position information indicating a predetermined number of positions as the second dummy data, the predetermined number of positions being selected randomly from points on peripheral roads of an observation point indicated by the environment data.

11. The information processing apparatus according to claim 7, wherein:
the control unit is configured to generate a value of zero as the first dummy data when addition calculation is utilized as statistical processing of each piece of data included in the first data, the statistical processing being performed for each measurement environment indicated by each piece of data included in the second data; and
the control unit is configured to generate a value of one as the first dummy data when multiplication calculation is utilized as the statistical processing.

12. The information processing apparatus according to claim 7, wherein the control unit is configured to:
set a dummy measurement point at which the first dummy data is assumed to have been measured;
determine whether or not a probability of being able to discriminate an actual measurement point is less than a predetermined threshold when the dummy measurement point and the actual measurement point indicated by the environment data are mixed; and
transmit the first data and the second data to the information processing apparatus mounted on the second vehicle when the control unit determines that the probability of being able to discriminate the actual measurement point is less than the predetermined threshold.

13. The information processing apparatus according to claim 1, wherein the control unit configured to execute:
receiving a result of statistical processing performed on each piece of data included in the first data that is kept encrypted for each measurement environment indicated by each piece of data included in the second data; and
decrypting the received first data and the received result.

14. An information processing method, comprising:
receiving, from a first vehicle, encrypted first data including one or more pieces of measurement data acquired by the first vehicle and one or more pieces of first dummy data that simulates the measurement data, and second data including one or more pieces of environment data each indicating a measurement environment of each piece of the measurement data and one or more pieces of second dummy data that corresponds to the first dummy data and simulates the environment data; and
performing statistical processing of each piece of data included in the first data for each measurement environment indicated by each piece of data included in the second data.

15. The information processing method according to claim 14, wherein performing the statistical processing includes executing the statistical processing without decrypting each piece of data included in the first data.

16. The information processing method according to claim 15, wherein performing the statistical processing includes performing the statistical processing on homomorphically encrypted data.

17. The information processing method according to claim 14, wherein performing the statistical processing includes performing the statistical processing when the first data and the second data of the number of pieces equal to or larger than a reference value are received for one or more observation points indicated by the environment data.

18. The information processing method according to claim 14, wherein performing the statistical processing includes calculating an average value of respective pieces of data included in the first data for each measurement environment indicated by each piece of data included in the second data.

19. The information processing method according to claim 14, further comprising transmitting a result of the statistical processing to another information processing apparatus.
